(19) United States
(12) Patent Application Publication
(10) Pub. No.: US 2019/0156412 A1
(43) Pub. Date: May 23, 2019

(54) Mills Zero-Coupon Loan

(71) Applicant: Coleen Althea Mills, Montgomery Village, MD (US)

(72) Inventor: Coleen Althea Mills, Montgomery Village, MD (US)

(21) Appl. No.: 15/815,709

(22) Filed: Nov. 17, 2017

(51) Int. Cl. G06Q 40/02

(52) U.S. Cl. CPC G06Q 40/025

(57) ABSTRACT

A loan structure designed with a built-in repayment mechanism so that the loan can be repaid at or prior to maturity, while simultaneously reducing default risk, increasing the borrower's ability to repay and stimulating economic growth.

This zero-coupon loan can be used globally by a variety of borrowers for financial and economic development, stability, expansion and revitalization.

### BACKGROUND

Developing economies (DE) and numerous entities have been borrowing money to fund infrastructure development, manufacturing and various projects for economic growth and stability for years. However, the loan for these large undertakings are usually from foreign, more industrialized nations in their hard currencies and the earnings to repay these loans are usually in the borrower's soft, domestic currencies. For example, Ethiopia borrows money from the United States (US) to build roads. Even if Ethiopia charges toll on these roads and increases taxes to repay the loan, these revenues are in Ethiopian Birr (EBT) and the loan still has to be repaid in foreign currency, US Dollar. This increase demand for hard currencies (from industrialized nations which are globally traded with expected stability) such as; the United States (US) Dollar, Japanese Yen, European Euro, German Mark and the British Pound Sterling, may also cause a relative devaluation of the local “soft” currencies in most developing nations. Let us say when the loan was originated the value of the DE's currency was US$1 equals EBT5 in year 1 and in year 2 of the loan the US$1 equals EBT10, it now cost two (2) times more EBT to repay the same amount of debt. This continuous relative devaluation and growing compounded interest makes it extremely difficult for DEs to repay their debts owed to external sources. We saw the “Latin American Debt Crisis” and defaults in the 1980's and 1990's and “Live Aide” for debt relief in the 2000's. Even today with the intervention of the World Bank and the International Monetary Fund, with loan restructuring in lieu of defaults and attempts to improve credit soundness with Basel I, II, and III, we continue to see the amount of outstanding debt grow beyond most of the DE's ability to repay and/or the austerity programs implemented that appears to have slowed economic growth and development significantly for these borrowers.

Investing Calculator

How much will an investment be worth in the future?

Investment $100,000,000

Annual Deposits $0.00

Rate of Return 15% (annually)

Years 50

[After 50 years, your investment will have grown to $108,365,744,158. In year 11, the earnings will exceed the outstanding loan balance.]

Investment Growth Over Time

| Year | Value |
|---|---|
| Start | $100,000,000 |
| 1 | $115,000,000 |
| 2 | $132,250,000 |
| 3 | $152,087,500 |
| 4 | $174,900,625 |
| 5 | $201,135,719 |
| 6 | $231,306,077 |
| 7 | $266,001,988 |
| 8 | $305,902,286 |
| 9 | $351,787,629 |
| 10 | $404,555,774 |
| 11 | $465,239,140 |
| 12 | $535,025,011 |
| 13 | $615,278,762 |
| 14 | $707,570,576 |
| 15 | $813,706,163 |
| 16 | $935,762,087 |
| 17 | $1,076,126,400 |
| 18 | $1,237,545,361 |
| 19 | $1,423,177,165 |
| 20 | $1,636,653,739 |
| 21 | $1,882,151,800 |
| 22 | $2,164,474,570 |
| 23 | $2,489,145,756 |
| 24 | $2,862,517,619 |
| 25 | $3,291,895,262 |
| 26 | $3,785,679,551 |
| 27 | $4,353,531,484 |
| 28 | $5,006,561,207 |
| 29 | $5,757,545,388 |
| 30 | $6,621,177,196 |
| 31 | $7,614,353,775 |
| 32 | $8,756,506,841 |
| 33 | $10,069,982,867 |
| 34 | $11,580,480,298 |
| 35 | $13,317,552,342 |
| 36 | $15,315,185,194 |
| 37 | $17,612,462,973 |
| 38 | $20,254,332,419 |
| 39 | $23,292,482,281 |
| 40 | $26,786,354,623 |
| 41 | $30,804,307,817 |
| 42 | $35,424,953,990 |
| 43 | $40,738,697,088 |
| 44 | $46,849,501,651 |
| 45 | $53,876,926,899 |
| 46 | $61,958,465,934 |
| 47 | $71,252,235,824 |
| 48 | $81,940,071,197 |
| 49 | $94,231,081,877 |
| 50 | $108,365,744,158 |

* Source- www.worksheets.org/invest and US Securities Exchange Commission www.Investor.gov

Amortization Calculator

Loan Amount $500,000,000

Loan Term 50 years

Interest Rate (APR) 2%

[The total loan and interest paid over 50 years is $791.371.877. By year 11 the entire loan can be repaid from the interest earned from the invested funds]

Annual Amortization Schedule

| | Beginning Balance | Interest | Principal | Ending Balance |
|---|---|---|---|---|
| 1 | $500,000,000.00 | $9,946,283.95 | $5,881,153.85 | $494,118,846.19 |
| 2 | $494,118,846.19 | $9,827,576.64 | $5,999,861.16 | $488,118,985.09 |
| 3 | $488,118,985.09 | $9,706,473.30 | $6,120,964.50 | $481,998,020.65 |
| 4 | $481,998,020.65 | $9,582,925.57 | $6,244,512.23 | $475,753,508.49 |
| 5 | $475,753,508.49 | $9,456,884.13 | $6,370,553.67 | $469,382,954.88 |
| 6 | $469,382,954.88 | $9,328,298.61 | $6,499,139.19 | $462,883,815.74 |
| 7 | $462,883,815.74 | $9,197,117.67 | $6,630,320.13 | $456,253,495.67 |
| 8 | $456,253,495.67 | $9,063,288.93 | $6,764,148.87 | $449,489,346.87 |
| 9 | $449,489,346.87 | $8,926,758.95 | $6,900,678.85 | $442,588,668.07 |
| 10 | $442,588,668.07 | $8,787,473.19 | $7,039,964.61 | $435,548,703.52 |
| 11 | $435,548,703.52 | $8,645,376.04 | $7,182,061.76 | $428,366,641.83 |
| 12 | $428,366,641.83 | $8,500,410.77 | $7,327,027.03 | $421,039,614.84 |
| 13 | $421,039,614.84 | $8,352,519.43 | $7,474,918.37 | $413,564,696.54 |
| 14 | $413,564,696.54 | $8,201,643.02 | $7,625,794.78 | $405,938,901.82 |
| 15 | $405,938,901.82 | $8,047,721.29 | $7,779,716.51 | $398,159,185.35 |
| 16 | $398,159,185.35 | $7,890,692.70 | $7,936,745.10 | $390,222,440.32 |
| 17 | $390,222,440.32 | $7,730,494.63 | $8,096,943.17 | $382,125,497.21 |
| 18 | $382,125,497.21 | $7,567,063.04 | $8,260,374.76 | $373,865,122.51 |
| 19 | $373,865,122.51 | $7,400,332.70 | $8,427,105.10 | $365,438,017.48 |
| 20 | $365,438,017.48 | $7,230,237.01 | $8,597,200.79 | $356,840,816.75 |
| 21 | $356,840,816.75 | $7,056,708.06 | $8,770,729.74 | $348,070,087.07 |
| 22 | $348,070,087.07 | $6,879,676.54 | $8,947,761.26 | $339,122,325.87 |
| 23 | $339,122,325.87 | $6,699,071.76 | $9,128,366.04 | $329,993,959.87 |
| 24 | $329,993,959.87 | $6,514,821.55 | $9,312,616.25 | $320,681,343.68 |
| 25 | $320,681,343.68 | $6,326,852.39 | $9,500,585.41 | $311,180,758.33 |
| 26 | $311,180,758.33 | $6,135,089.22 | $9,692,348.58 | $301,488,409.79 |
| 27 | $301,488,409.79 | $5,939,455.39 | $9,887,982.41 | $291,600,427.45 |
| 28 | $291,600,427.45 | $5,739,872.85 | $10,087,564.95 | $281,512,862.54 |
| 29 | $281,512,862.54 | $5,536,261.83 | $10,291,175.97 | $271,221,686.64 |
| 30 | $271,221,686.64 | $5,328,541.07 | $10,498,896.73 | $260,722,789.99 |
| 31 | $260,722,789.99 | $5,116,627.63 | $10,710,810.17 | $250,011,979.87 |
| 32 | $250,011,979.87 | $4,900,436.82 | $10,927,000.98 | $239,084,978.95 |
| 33 | $239,084,978.95 | $4,679,882.35 | $11,147,555.45 | $227,937,423.56 |
| 34 | $227,937,423.56 | $4,454,876.14 | $11,372,561.66 | $216,564,861.94 |
| 35 | $216,564,861.94 | $4,225,328.30 | $11,602,109.50 | $204,962,752.50 |
| 36 | $204,962,752.50 | $3,991,147.18 | $11,836,290.62 | $193,126,461.95 |
| 37 | $193,126,461.95 | $3,752,239.28 | $12,075,198.52 | $181,051,263.50 |
| 38 | $181,051,263.50 | $3,508,509.20 | $12,318,928.60 | $168,732,334.95 |
| 39 | $168,732,334.95 | $3,259,859.56 | $12,567,578.24 | $156,164,756.77 |
| 40 | $156,164,756.77 | $3,006,191.09 | $12,821,246.71 | $143,343,510.12 |
| 41 | $143,343,510.12 | $2,747,402.48 | $13,080,035.32 | $130,263,474.87 |
| 42 | $130,263,474.87 | $2,483,390.41 | $13,344,047.39 | $116,919,427.53 |
| 43 | $116,919,427.53 | $2,214,049.39 | $13,613,388.41 | $103,306,039.20 |
| 44 | $103,306,039.20 | $1,939,271.94 | $13,888,165.86 | $89,417,873.39 |
| 45 | $89,417,873.39 | $1,658,948.26 | $14,168,489.54 | $75,249,383.90 |
| 46 | $75,249,383.90 | $1,372,966.43 | $14,454,471.37 | $60,794,912.59 |
| 47 | $60,794,912.59 | $1,081,212.22 | $14,746,225.58 | $46,048,687.08 |
| 48 | $46,048,687.08 | $783,569.18 | $15,043,868.62 | $31,004,818.51 |
| 49 | $31,004,818.51 | $479,918.39 | $15,347,519.41 | $15,657,299.15 |
| 50 | $15,657,299.15 | $170,138.59 | $15,657,299.21 | $0.00 |

In addition to the $107.6 Billion profit, the proceeds from the invested funds are enough to repay the loan in entirety by the 11^{th} year (loan amount owed $435million and earnings from investment $465 million)]
*Source- http://www.calculator.net/amortization-calculator
*-APR- means Annual Percentage Rate
*$- means United States Dollar

### INVENTION SUMMARY

There are many economically depressed communities around the globe. Cities like Detroit, Mich. in the US and developing nations overseas with extensive poverty which seek economic and financial growth, stimulation and/or revitalization. The added challenges for developing countries are most of the foreign loans made to them are in “hard”/foreign currencies and their earnings are in their “soft”/local currencies. While currency conversion is not a major factor within the US, for developing economies in and outside the US, conventional loans are unlikely to reverse the negative cycle and repayment is still dependent solely on the borrower's ability to repay. I have developed this particular risk-management loan structure to be effective globally. The invention is designed to curtail loan defaults by keeping the repayment and the loan in hard (or similar) currencies and is not solely dependent on the borrower's ability to repay. This makes it far less burdensome on the borrower, increases the assurance to the lender of the loan being repaid while simultaneously stimulate economic growth.

For example:

The United States agrees to lend Ethiopia US$500 MILLION for infrastructure development at 2% for 50 years. US$ 100 MILLION (20% of the loan proceeds) is escrowed and invested at a 15% rate of return. The US$ 500 MILLION loan amortized over 50 years is US$791.4 MILLION and the US$100 MILLION investment will be over US$ 108.4 BILLION. In addition to the potential earnings of over US$ 107Billion from the invested escrowed funds, the loan could be paid off in entirety by the eleventh (11^{th}) year solely from interest earnings. Therefore, the loan can be repaid with the funds that are set aside and zero is due prior to maturity.

With the Mills Zero-Coupon Loan the lender provides the borrower with a long-term, relatively low interest rate loan and a percentage of the loan proceeds (for example 10% to 30%) is set aside in the same currency as the loan (or another hard or similar currency) and invested at a relatively higher rate of return than the interest rate of loan so that the loan can be repaid at or prior to maturity. This simultaneously reduces the risk of default, provides additional security to the lender, reduces or eliminates the burden of debt repayment by the borrower and stimulates economic growth. The exact percentage that is escrowed for investment and how the funds are invested and managed should be mutually agreed to by both parties in a cooperative effort with the goal of reaching zero (0) amount due at or before maturity.

1. The Mills Zero-Coupon Loan reduces the default risk by eliminating the risk of the borrower's ability to repay the loan as the only source of repayment by providing two (2) sources of repayment. One from the earnings from the invested escrowed funds and the other from the borrower's earnings. Additionally, by having the lender and borrower mutually agreeing on the management overseeing and/or monitoring of the escrowed funds invested, even when placed with a third-party investment entity, there is added guarantee that the funds will be properly managed to yield rates of returns to repayment the loan at or prior to maturity. Even if the amount earned from the invested funds is not enough to fully pay off the loan, it is still an excellent default risk tool because the earnings that are generated will be applied to the repayment of the loan.

2. In many Developing Countries, the governments and private entities borrow money in a foreign (“hard”) currency, the loan has to be repaid in that foreign currency. However, the borrower's earnings are in a local (“soft”) currency. The Mills Zero-Coupon Loan significantly reduces the foreign exchange risk and increases the borrower's ability to repay by investing the escrowed funds in the same currency (or another “hard” currency) as the loan so that the loan can be repaid in the foreign currency in which the funds were borrowed.

3. Funds that are earned in a Developing Economy that would usually have to be used for debt servicing/loan repayment can be applied to other local projects instead. This will increase the circulation of money within the local economy, thus continuing a cycle of positive economic growth and development. So, the Mills Zero-Coupon Loan is especially helpful in building and revitalizing economically depressed and or disadvantaged companies, communities, and countries. Global capital markets can also benefit from the increased liquidity from the invested escrow funds and the additional circulation of funds.
